(19) United States
(12) Patent Application Publication
(10) Pub. No.: US 2005/0048335 A1
(43) Pub. Date: Mar. 3, 2005

(54) Apparatus and method for regulating hybrid fuel cell power system output

(76) Inventors: Robert E. Fields III, Santa Fe, NM (US); Mahlon S. Wilson, White Rock, NM (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/650,197

(22) Filed: Aug. 26, 2003

(51) Int. Cl. H01M 8/00

(52) U.S. Cl. 429/22; 429/23; 429/13

(57) ABSTRACT

An apparatus and accompanying method for controlling a fuel cell power system having a fuel cell stack with a connected energy storage medium. A voltage monitoring circuit is connected to the individual fuel cells forming a fuel cell stack. A regulating circuit receives signals from the voltage monitoring circuit and outputs a control signal to a DC-DC converter connected between the fuel cell stack and an output bus and energy storage medium. The regulating circuit controls the DC-DC converter voltage output to a maximum power that the fuel cell stack can provide.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to control of fuel cell power output and, more particularly, to regulating the power output from a fuel cell stack in a hybrid power pack configuration of a fuel cell and an auxiliary power source.

### BACKGROUND OF THE INVENTION

A fuel cell hybrid configuration, as used herein, is defined as a configuration of one or more fuel cells connected in parallel with one or more energy storage mediums. A fuel cell stack, as used herein, is defined as a configuration of more than one fuel cell connected in series. An energy storage medium may be selected from any device capable of storing electrical energy and providing that stored energy at a latter time. Examples of energy storage media include batteries, capacitors, flywheels, superconducting electromagnets, and supercapacitors.

The fuel cell hybrid configuration allows for efficient sizing of the subject fuel cell or cells, only the average power demanded by the load must be provided, while the auxiliary power source provides additional power to meet peak load requirements. The present invention utilizes a battery or batteries, hereinafter referred to as a battery, as an auxiliary power source.

When power is demanded from the simple hybrid system it is automatically drawn from both the fuel cell and the battery. When the power demand subsequently decreases, the lower voltage on the battery due to discharge causes available fuel cell current to flow into the battery for recharging the battery. While this hybrid configuration is simple, there are a few limitations.

First, the recharge rate of the battery source depends on the differing voltage output of the battery and the fuel cell stack. As the battery is recharging after a discharge, the initial charging rate of the battery will be higher, as the fuel cell stack is operating at a high power as a result of the lower system output voltage. However, as the battery voltage increases from recharging, the fuel cell moves away from operating at higher power output (assuming the load on the system remains steady) and the battery recharge rate subsequently decreases with a consequent reduction in fuel cell power output. The method of operation inherent in the present invention holds the fuel cell at designed maximum power output and, thus, reduces the comparative time required to recharge the battery. Consequently, power available to the primary load is maximized and the required size of the battery for the peak load cycle is reduced.

Second, the simple method of connecting the fuel cell and battery together in parallel offers no protection from a condition known as “fuel cell reversal”. Fuel cell reversal occurs when one or more cells in a fuel cell stack are not able to supply enough current to the circuit, such that the potential across those cells becomes negative (reverse bias), which causes damage to the reversed fuel cells. Parallel connection of a fuel cell stack with an auxiliary battery forces stack voltage to be equal to battery voltage. Under high demand battery voltage and stack voltage will decrease, increasing power demand on the stack and potentially exceeding the ability of one or more cells to deliver power, thus leading to cell reversal.

Last, a hybrid power system must smoothly move from a configuration where there is one power source and two loads (the actual load on the system plus recharge of the battery), and two power sources and one load (the fuel cell and battery both supplying power to the actual load). If the output voltage of the fuel cell is fixed and the output voltage of the battery drops under load, then there will always be one power source and two loads and no advantage is realized from a hybrid configuration. In contrast, the present invention adjusts the output voltage of the fuel cell to the approximate voltage output of the battery, so that the load is efficiently shared.

The present invention is a method and apparatus to regulate the power output of a fuel cell stack configured in a hybrid power configuration such that maximum power is generally available to the load, all while monitoring and ensuring that each individual fuel cell within the fuel cell stack is not damaged from a reverse bias condition. This form of operation is particularly suited to application in small electric vehicles, such as 3- and 4-wheel personal mobility vehicles, where maximum operating efficiency is of secondary concern. In addition, this method maximizes power available from the system and allows the use of smaller fuel cells and hybrid power systems that reduce initial cost. These properties suit the system to any application where minimum weight, small size, and maximum power are considerations primary to system efficiency.

U.S. Pat. No. 5,714,874 issued on Feb. 3, 1998, “Fuel Cell Voltage Generator”, addresses a similar hybrid configuration as the present invention. A microprocessor is used to regulate the maximum intensity value of the current going through a DC-DC converter connected to the output of the fuel cell. The regulation is responsive to the voltage measured at the terminals of the fuel cell in order to maintain the voltage near a preset reference value. However, the disclosed regulation scheme does not monitor the individual fuel cells of the subject fuel cell stack to ensure that a reverse bias condition does not damage the system.

U.S. Pat. No. 6,321,145, issued on Nov. 20, 2001, “Method and Apparatus for a Fuel Cell Propulsion System”, discloses a circuit to regulate fuel/air flows to reformer/fuel cell, and to boost converters, based on load demand and an external control signal. This method only uses boost converters for conditioning the power from the fuel cell, which requires the fuel cell to have an output voltage lower than that of the battery or system bus depending on implementation. In an average load condition, most or all of the power would be supplied by the fuel cell and boost converter. Operating at low voltage and concomitant higher current for a given power output implies higher resistive losses in the stack, stack wiring, and connections, and/or higher weight due to larger wire and connection gauges. The '145 patent also describes various fuel cell controlling techniques based on an external control current signal and a programmable load controller, but does not teach cell monitoring or controlling the stack based on stack voltage. The circuit does not appear to function as an autonomous plug-in replacement for other power systems.

U.S. Pat. No. 6,369,461, issued on Apr. 9, 2002, “High Efficiency Power Conditioner Employing Low Voltage DC Bus and Buck and Boost Converters”, discloses a system that does not regulate the fuel cell output directly, but instead regulates the charge voltage of the hybrid battery, boosts the output of the hybrid battery to the DC bus, and allows the battery to dump power through a diode to the bus when the bus voltage drops too low. This system requires two regulator circuits to function; one regulator circuit that charges the battery from the DC bus and another regulator circuit which supplies power from the battery to the DC bus. This configuration adds inefficiencies in both charge and discharge cycles of the battery. There appears to be no provision for protecting the fuel cell from low voltage/high power operation that could reverse bias and damage individual fuel cells. The DC-DC converter that couples the battery to the DC-DC bus must also be sized to handle the highest power the battery may be expected to deliver when the difference between the battery and the bus voltage is not high enough for the pass diode to conduct.

U.S. Pat. No. 6,497,974, issued on Dec. 24, 2002, “Fuel Cell Power System, Method of Distributing Power, and Method of Operating a Fuel Cell Power System”, details a fuel cell power supply configuration where ultra-capacitors and batteries are arranged in a parallel circuit with individual, or small numbers of fuel cells, and that are connected and disconnected, as needed, to supply transient power to the load. The configuration taught by the '974 patent provides operational flexibility and the ability to produce a sinusoidal output directly, but at the cost of very complex additional circuitry. The invention switches cells into and out of the circuit to provide a voltage summation that distributes load, and, if desired, can also approximate a sinusoid. However, this configuration requires many high current capacity connections to either a bulky stack configuration or many individual fuel cells which serves to increase size and weight of the system. In addition, access to individual supercapacitors and/or batteries also increases size and weight of the system.

U.S. Pat. No. 6,428,918, issued on Aug. 6, 2002, “Fuel Cell Power Systems, Direct Current Voltage Converters, Fuel Cell Power Generation Methods, Power Conditioning Methods and Direct Current Power Conditioning Methods, describes selectively connecting and disconnecting fuel cell cartridges to control output voltage. Similar to U.S. Pat. Nos. 6,387,556 and 6,497,974, supra, the system does not control the output voltage of the stack through dynamically controlling the loading in a hybrid configuration, but instead connects additional cells when stack voltage drops or removes them when voltage rises. Duty cycles and numbers of cells in operation are adjusted as needed to get desired output voltage levels. The '918 patent teaches a fuel cell power system and not a hybrid battery/fuel cell power system. It also requires an excess of cells/modules and complex additional circuitry.

U.S. Patent Application 2002/0162694, filed on Oct. 9, 2001, “Operating Load Control for Fuel Cell Power System Fuel Cell Vehicle”, describes demand measurements used to control compressor, reformer, and combustor in an electric vehicle drive system. The system is based on the state of charge (SOC) of a battery and activates the reformer/fuel cell when a lower threshold is reached to recharge the battery, and then turns the reformer/fuel cell off when upper SOC is reached. This strategy minimizes start/stop cycles of the reformer, which is an energy intensive process and also works to maintain a minimum load on the fuel cell to decrease the need for high precision valves and other devices that are required in a reformer/fuel cell system than would otherwise be required to operate at lower power levels. The system also operates in a high-efficiency, constant load mode when the system load is low enough. The system cycles between high and low setpoints for the battery SOC. The system is designed for maximum efficiency and single point operation for use with reformer-equipped systems. To operate in an on/off mode, the hybrid battery must be sized to handle all of the power required by the load for a period of time that maximizes the efficiency of starting and stopping the fuel reforming system. In addition, the fuel cell must be sized large enough to supply these same power requirements while also supplying enough additional power to recharge the battery. The system described is not designed to minimize the hybrid battery size and the size of the fuel cell.

The present invention was designed to overcome many of the design deficiencies discussed above. The present invention does not utilize valves or other devices that require a high precision to operate, so operating at some minimum specified power level is not necessary. The present invention also minimizes the stack and battery capacities so as to decrease initial cost and size. The present invention, when used as a power source for propulsion systems, does not require a control input from the vehicle. The present invention protects the fuel cell stack and provides maximum available power to the load through high-power recharge of the battery. Last, the present invention eliminates the use of complex switching circuitry, the high-current connections to individual fuel cells, while still providing the ability to deliver high peak energies.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention includes an apparatus and accompanying method for controlling a fuel cell power system having a fuel cell stack with a connected energy storage medium. A voltage monitoring circuit is connected to the individual fuel cells forming a fuel cell stack. A regulating circuit receives signals from the voltage monitoring circuit and outputs a control signal to a DC-DC converter connected between the fuel cell stack and an output bus and energy storage medium. The regulating circuit controls the DC-DC converter voltage output to a maximum power that the fuel cell stack can provide.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a block diagram of the present invention hybrid fuel cell power system.

FIGS. 2a and 2b are flowcharts of the regulating logic controlling the hybrid fuel cell power system output.

FIG. 3 graphically shows a typical fuel cell polarization curve.

FIG. 4 is a schematic showing the interconnections between the circuit blocks of the DC-DC converter regulator circuit.

FIG. 5 is a schematic showing the circuit connections to the DC-DC converter.

FIG. 6 is schematic detailing the differential amplifiers and gain stage for current and voltage monitoring into and out of the DC-DC converter.

FIG. 7 is a schematic of the connections to the Atmel ATMega163L microcontroller that controls the DC-DC converter.

FIG. 8 is a schematic detailing the optically-isolated DC-DC converter output controller circuit and power supply.

FIG. 9 is a schematic detailing the interconnections for the individual cell voltage monitoring circuitry.

FIG. 10 is a schematic of the Analog Devices AD629 high common mode voltage difference amplifier connections for a fuel cell stack comprising 10 fuel cells numbered 1-10.

FIG. 11 is a schematic detailing the Analog Devices ADG506 16 multiplexers and Sallen-Key analog filters.

FIG. 12 is a schematic of another Atmel ATMega163L micro-controller used to select which fuel cell voltage to monitor and which communicates with the Atmel micro-controller that regulates the DC-DC converter output voltage.

FIG. 13a is a block diagram of a hybrid fuel cell power system with an additional DC-DC converter to supply a fixed DC output voltage.

FIG. 13b is a block diagram of a hybrid fuel cell power system with an additional DC-AC inverter to supply a constant AC output voltage.

### DETAILED DESCRIPTION

The present invention is a method and apparatus to regulate the power output of a hybrid fuel cell power configuration such that maximum power is generally available to the load. The apparatus regulates the voltage on a fuel cell stack, hereinafter “stack”, indirectly by controlling the output voltage of an incorporated buck/boost DC-DC converter. The control method shares the load automatically between the fuel cell stack and the battery such that the battery is kept at maximum possible charge level. When the system load is decreased and the battery is fully recharged, the corresponding increase in fuel cell stack voltage will improve the operating efficiency of the fuel cell stack.

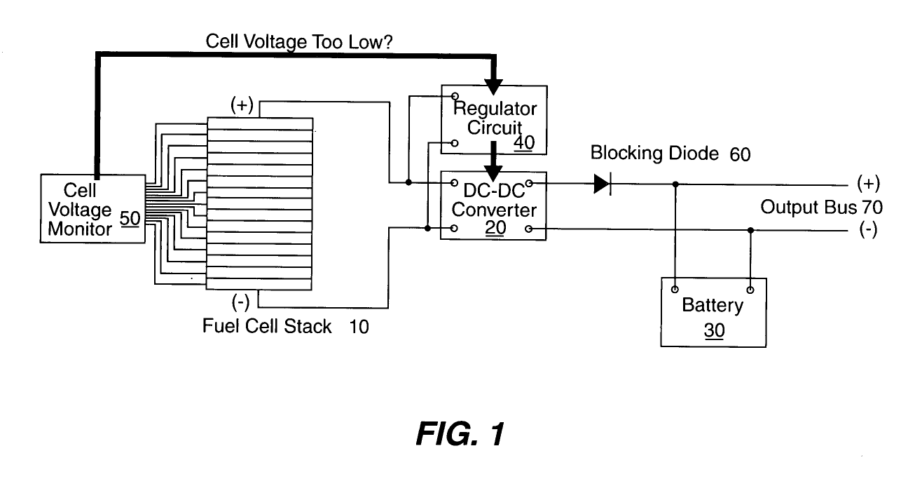

The present invention emphasizes simplicity while providing maximum power to the load. Referring now to FIG. 1, a block diagram of the present invention hybrid fuel cell power system comprising fuel cell stack 10, DC-DC converter 20, and battery 30. Regulator circuit 40 monitors fuel cell stack 10 output voltage and controls the output voltage of DC-DC converter 20. Cell voltage monitor 50 is used to determine if any individual cells are not able to deliver sufficient power. Regulator circuit 40 is micro-controller-based and the functionality is dependent on firmware residing in the microcontroller flash memory. Blocking diode 60 ensures that no reverse current flows from battery 30 into DC-DC converter 20.

The control circuit, comprising regulator circuit 40 and cell voltage monitor 50, functions by monitoring the stack voltage and holding the stack at a setpoint voltage value generally corresponding to maximum stack power output. This is accomplished by raising or lowering the output voltage of DC-DC converter 20 connected to the output of stack 10.

When fuel cell stack 10 output voltage is higher than a setpoint corresponding to maximum power, regulator circuit 40 attempts to increase the power drawn from stack 10. To increase power load on fuel cell stack 10, regulator circuit 40 commands the output voltage of DC-DC converter 20 to increase, which increases voltage on output bus 70 and across battery 30. Increasing the voltage on output bus 70 causes battery 30 to charge to a higher level and thus store power from fuel cell stack 10. A higher voltage on output bus 70 may or may not also provide more power to the load depending on the characteristics of the load.

Similarly, if fuel cell stack 10 output voltage is lower than the setpoint, regulator circuit 40 decreases power drawn from stack 10 by decreasing DC-DC converter 20 output voltage. This reduces the voltage on output bus 70 and across battery 30, which, under low loading conditions, causes battery 30 to charge at a lower rate, and thus decrease the load on fuel cell stack 10, or, under high loading conditions, causes battery 30 to assume a larger share of the ultimate load.

Regulator circuit 40 limits the range of voltages over which the output voltage of DC-DC converter 20 may be adjusted. Battery 30 voltage at maximum charge determines the highest voltage to which DC-DC converter 20 may be adjusted. The lowest DC-DC converter 20 output voltage is determined by the minimum voltage that may be present on output bus 70 under conditions of maximum load. These voltage limits prevent battery 30 from overcharging at low load and allows regulator circuit 40 to limit power drawn from stack 10 at high load. While DC-DC converter 20 output voltage is within this range, the circuit is regulated. However, when DC-DC converter 20 output voltage reaches either extreme and becomes limited by regulator circuit 40, the circuit becomes unregulated.

Under low loading conditions, stack 10 delivers more power than the load requires and stack 10 voltage attempts to rise. While in regulation, DC-DC converter 20 output voltage is commanded to rise by regulator circuit 40 to maintain fuel cell stack 10 output potential at a voltage corresponding to maximum power output. During this period, battery 30 recharges at a rate corresponding to fuel cell stack 10 maximum power output. As battery 30 approaches the maximum possible charge, the current flow and power into battery 30 decreased. If the total load on the system remains low, DC-DC converter 20 reaches maximum output voltage, and fuel cell stack 10 becomes unregulated because load cannot be maintained on fuel cell stack 10 by DC-DC converter 20. As the power demand decreases on fuel cell stack 10, and the output voltage increases, the fuel cell system automatically moves into higher efficiency operation.

Under loading conditions that equal stack 10 power output capability, output bus 70 voltage moves to and regulates at a voltage equal to that of battery 30. There is then no net flow of current into or out of battery 30 and all system power is supplied by stack 10.

Under load conditions that require more power than stack 10 alone can deliver, output bus 70 voltage drops below that of battery 30, and current flows from fuel cell stack 10, through DC-DC converter 20, and also from battery 30 to output bus 70 (the load). The load increases on stack 10 as lower output bus 70 voltage also draws more current from DC-DC converter 20. As DC-DC converter 20 delivers this current, the input impedance of DC-DC converter 20 decreases, drawing more current from stack 10. Stack 10 output voltage consequently decreases and regulator circuit 40 regulates stack 10 voltage back to the maximum power output setpoint by reducing the output voltage of DC-DC converter 20. As battery 30 discharges, battery 30 voltage and output bus 70 voltage decrease and DC-DC converter 20 output voltage follows output bus 70 voltage, delivering as much power as stack 10 can supply without driving stack 10 voltage low enough to reverse bias and damage individual fuel cells in stack 10.

The control circuit design provides automatic protection for the stack, as the individual fuel cells and combined stack voltages are monitored, and determines the maximum possible stack power output. For example, the DC-DC converter output voltage is reduced when monitored stack voltage decreases, and increased when stack voltage increases. If any monitored individual cell voltage falls below a predetermined setpoint that indicates a potential cell reversal condition, the stack is electrically disconnected from the load by the controller. The controller also electrically disconnects the stack if hydrogen fuel pressure falls below a predetermined setpoint. The system operates without regard for characteristics of the load.

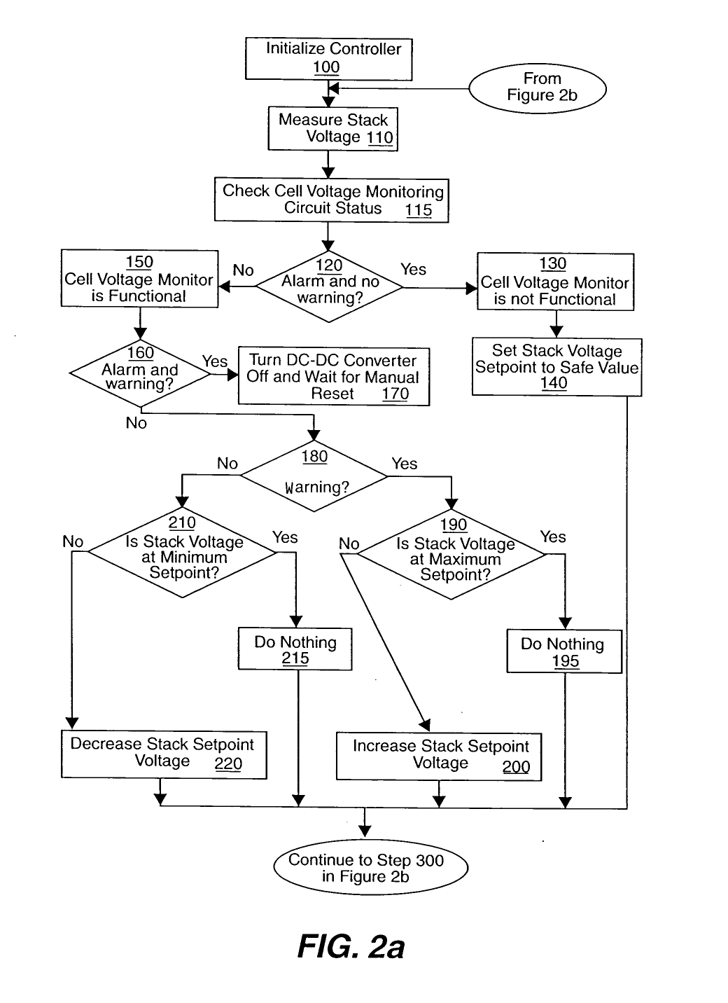

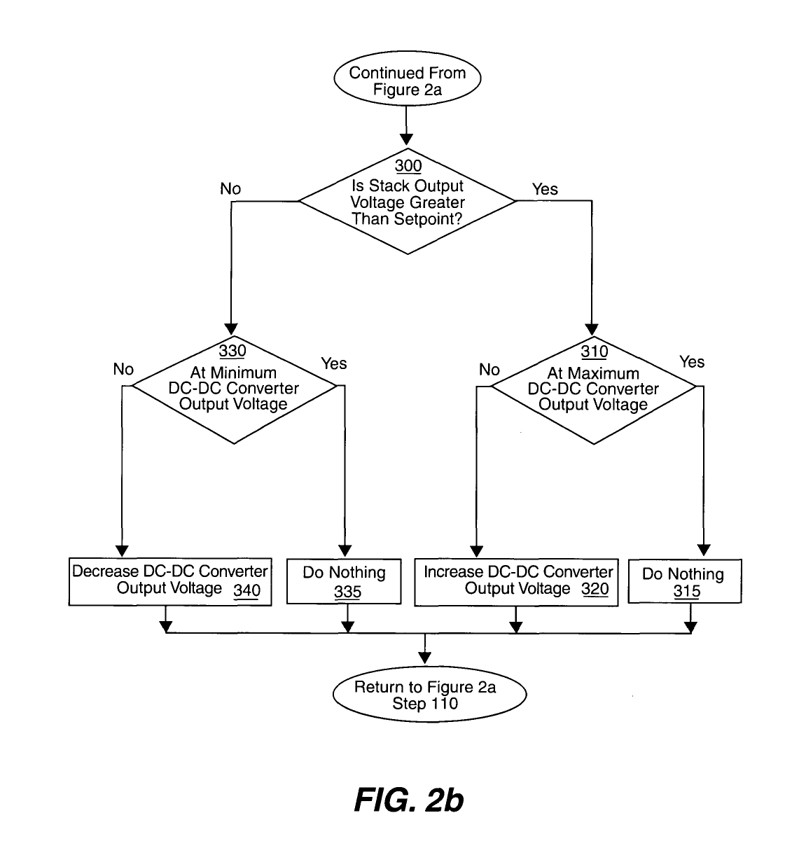

FIGS. 2a and 2b are flowcharts displaying the method for the control logic of the present invention. First, in FIG. 2a at step 100, the microcontroller and firmware of regulator circuit 40 (FIG. 1) are initialized. This includes (1) initializing variables within the firmware and a watchdog timer, and (2) configuring input/output (I/O) ports for proper direction and state and onboard peripherals, such as the analog to digital converter (ADC). The firmware then enters an endless loop for processing the stack regulation algorithm.

The microcontroller then uses the onboard ADC to measure the fuel cell stack voltage, which is the parameter that is regulated, at step 110. This is followed by checking the cell voltage monitoring circuit status, at step 115. The cell voltage monitoring circuit status is checked on two signal lines: ‘Alarm’ and ‘Warning’. These two signals are determined by the system designer and correspond to the condition of one or more individual cell voltages sensed below a warning level and possibly below an alarm level. The alarm level is chosen to indicate imminent danger of damage to an individual fuel cell. The warning level is the regulation point chosen for maximum power output of an individual fuel cell.

The microcontroller checks the state of the two signal lines at step 120. An alarm state without a warning is indicative of an error condition that denotes the cell voltage monitoring circuit is not functioning. This condition means that the regulation circuit is now only able to monitor fuel cell stack performance based on the overall fuel cell stack voltage. Thus, action must be taken to operate the fuel cell stack at a power level that reduces the chance of damage to individual fuel cells at step 130. The stack regulation setpoint is then set at step 140 to a voltage that is considered high enough that the stack is operated at a power density low enough that the risk of damage to a single cell is highly unlikely.

If, at step 120, it is determined that the cell voltage monitoring circuit is working, then the program continues, in step 150, as any situation that could cause damage to an individual fuel cell will be reported to the microcontroller. Thus, the fuel cell stack may be operated at maximum power.

At step 160, there is a test of the fuel cell stack status. If there is an alarm and a warning, this indicates that a cell is in imminent danger of being damaged due to an extremely low cell voltage. This is an error condition that must be remedied immediately or damage to the fuel cell stack is highly likely. Therefore, in step 170, if there is an alarm and a warning, the DC-DC converter that is used to regulate fuel cell stack output is turned off by the microcontroller and latched such that manual intervention on the part of the user is necessary to diagnose and remedy the error condition. The cell voltage monitoring circuit can also use the alarm and warning state to communicate other severe fault conditions such as low fuel pressure, excessive temperature in the fuel cell stack, tip over, etc.

If, at step 160, there is no condition of an alarm and a warning, program proceeds to step 180, where it is determined if there is a warning but no alarm. If there is a warning at step 180 this indicates that one or more fuel cells are not capable of supplying as much power as the other cells, and that their voltage has dropped low enough to be of concern. At step 190, a determination is made concerning the warning of step 180. A logic sequence determines whether or not the fuel cell stack is at the maximum stack voltage setpoint. If it is at the maximum stack voltage setpoint, then at step 195, there is no control action that can resolve the problem. Therefore, the stack will either recover due to changing external conditions, or, as conditions worsen and the firmware restarts the control algorithm, the controller will turn the DC-DC converter off at step 170.

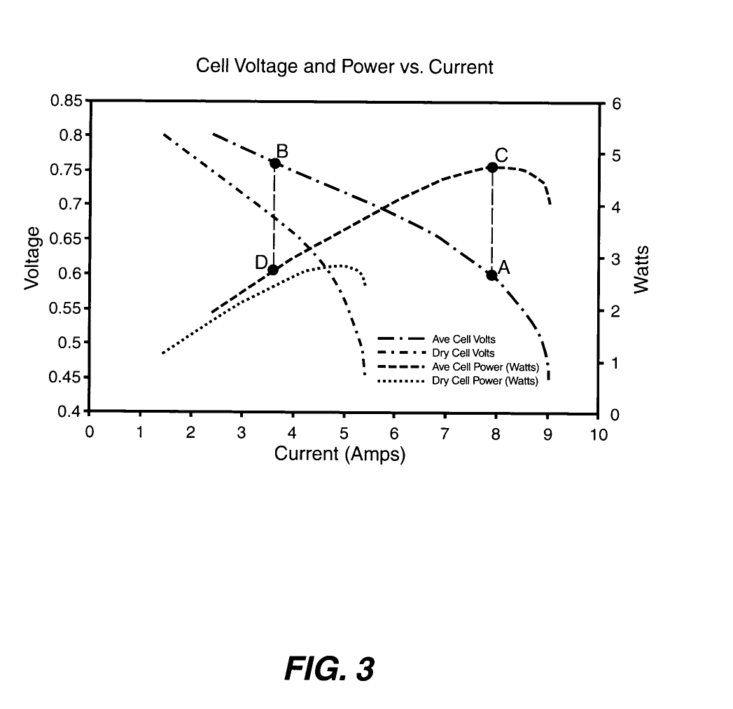

If, at step 190, the fuel cell stack is not at the maximum stack voltage setpoint, then, at step 200, the regulation circuit increases the fuel cell stack voltage setpoint value. Referring to FIG. 3, a graph of a typical fuel cell polarization curve, as the voltage is increased from point A to point B the corresponding cell output power drops off from point C to point D. Thus, the concern raised at step 180 of one or more fuel cells not being capable of producing the called for power is resolved.

Returning to step 180, if there is no warning or alarm, then, at step 210, a determination is made as to whether or not the fuel cell stack is operating at the minimum stack voltage setpoint. If the fuel cell stack is operating at the minimum stack voltage setpoint, then at step 215, the controller cannot drive the setpoint any lower without a resultant power decrease and creation of a control instability; therefore, no control actions occur. If the fuel cell stack is not operating at the minimum stack voltage setpoint, then, at step 220, the stack voltage setpoint is decreased. Referring once again to FIG. 3, as the stack voltage setpoint is decreased from point B towards point A the fuel cell power output increases from point D towards point C. Thus, the fuel cell stack supplies more power to the load; the stack can continue to be loaded even more, as the control algorithm repeats, until it reaches the maximum power capability and individual cells begin to trigger a warning.

The above discussion is directed to how the microcontroller operates in consideration of the status of individual fuel cells that make up the fuel cell stack. The following discussion is directed to how the microcontroller operates in consideration of the fuel cell stack and the load on the hybrid fuel cell system.

In FIG. 2b at step 300, the stack regulation setpoint is compared to the actual stack voltage to determine whether the load on the stack needs to be increased or decreased for proper regulation. If it is determined that the stack voltage is greater than the stack regulation setpoint, the process moves to step 310 to determine if it is at the maximum DC-DC converter output setpoint. The DC-DC converter output setpoint is determined by the system designer and is the lowest of the following system limitations: (1) maximum voltage required by load; (2) maximum voltage of the energy storage medium; and (3) maximum voltage that the DC-DC converter can supply.

If it is determined, in step 310, that the DC-DC converter output voltage is not already at its maximum setting, then in step 320, the microcontroller adjusts the voltage applied to the DC-DC converter Secondary Control (SC) input to increase the output voltage; increasing the output voltage of the DC-DC converter correspondingly increases loading on the fuel cell stack. The algorithm then returns to step 110 to start the decision and control tree over again for the next cycle.

If, at step 310, it is determined that the DC-DC converter output voltage is at the maximum setpoint, then at step 315, nothing is done and the control algorithm continues on in the loop to Step 110. The system at this point becomes unregulated, as the energy storage medium is fully charged. The resulting effect is that individual fuel cell voltages will begin to rise, moving from point A to point B in FIG. 3, with a corresponding increase in fuel cell efficiency.

If, in step 300, it is determined that the stack voltage is less than the stack regulation setpoint, then, in step 330, a determination is made if the stack is at the minimum setpoint. If the DC-DC converter output voltage is at the minimum setpoint, then at step 335, nothing can be done, and the control algorithm continues in the loop to Step 110 and there is an increased probability that the loads of the power system will cause the DC-DC converter to turn off at step 170.

If the DC-DC converter output voltage is not at the minimum setpoint, then, in step 340, the output voltage of the DC-DC converter is decreased to decrease loading on the fuel cell stack. The microcontroller adjusts the voltage applied to the DC-DC converter SC input to decrease the output voltage. The algorithm then returns to step 110 to start the decision and control tree over again for the next cycle.

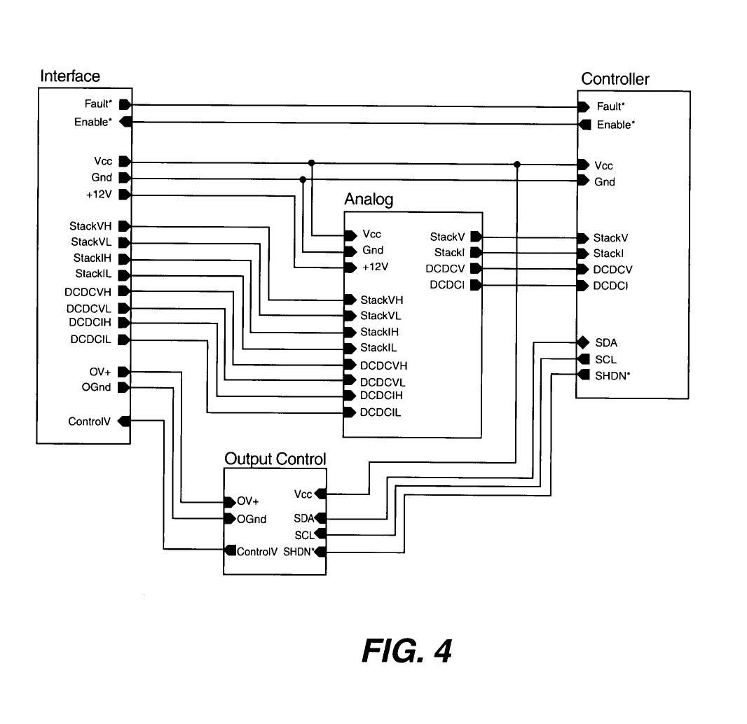

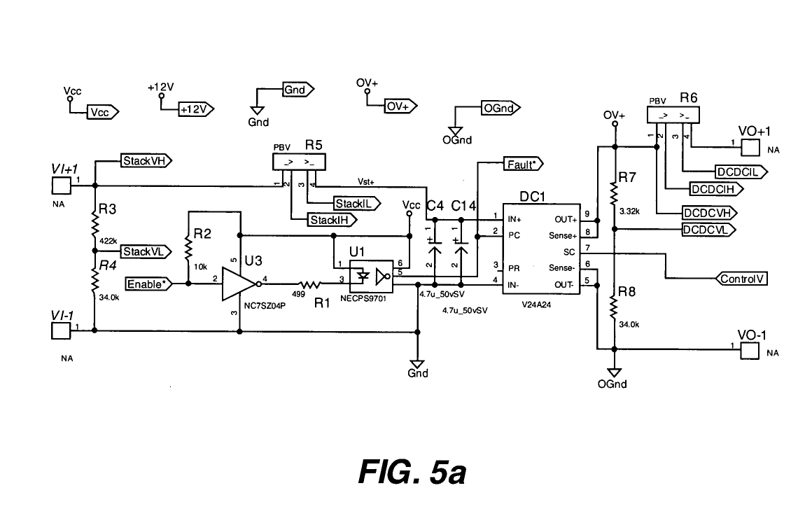

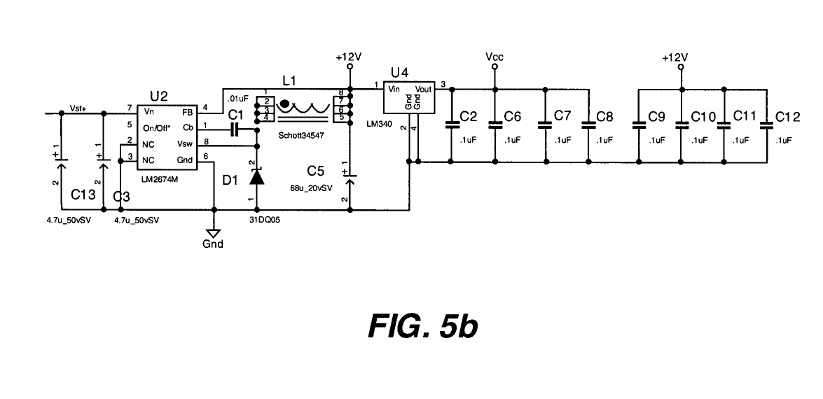

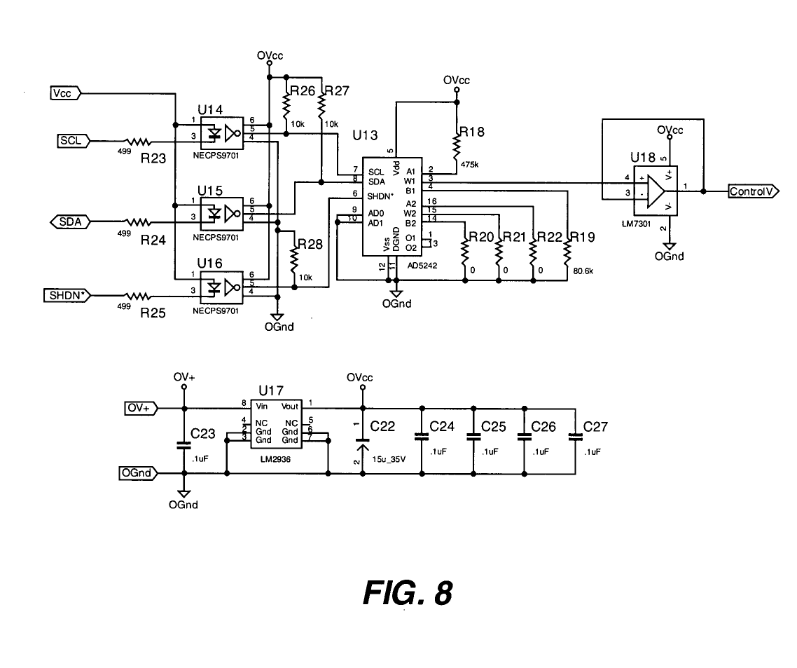

The control circuit is detailed in FIGS. 4 though 12. FIGS. 5-8 are schematics of the regulator circuit. FIGS. 8-11 are schematics of the cell voltage monitoring circuit.

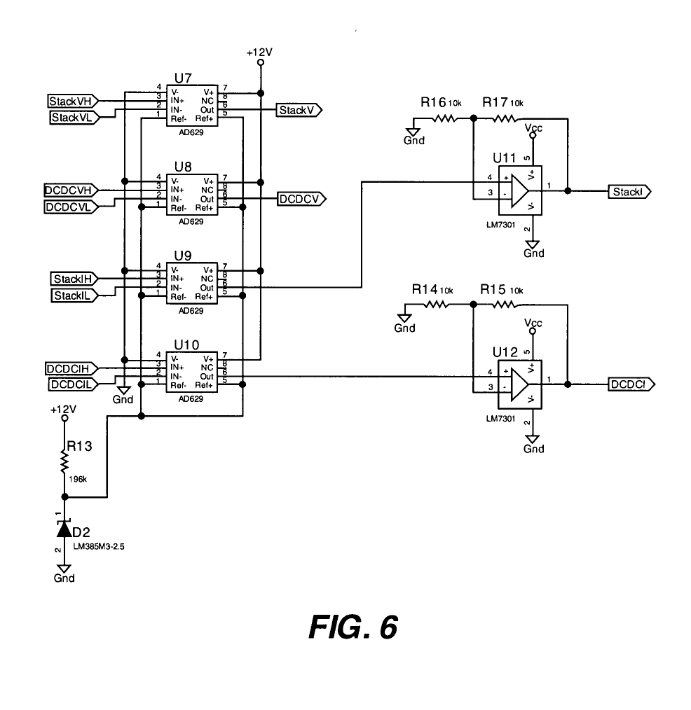

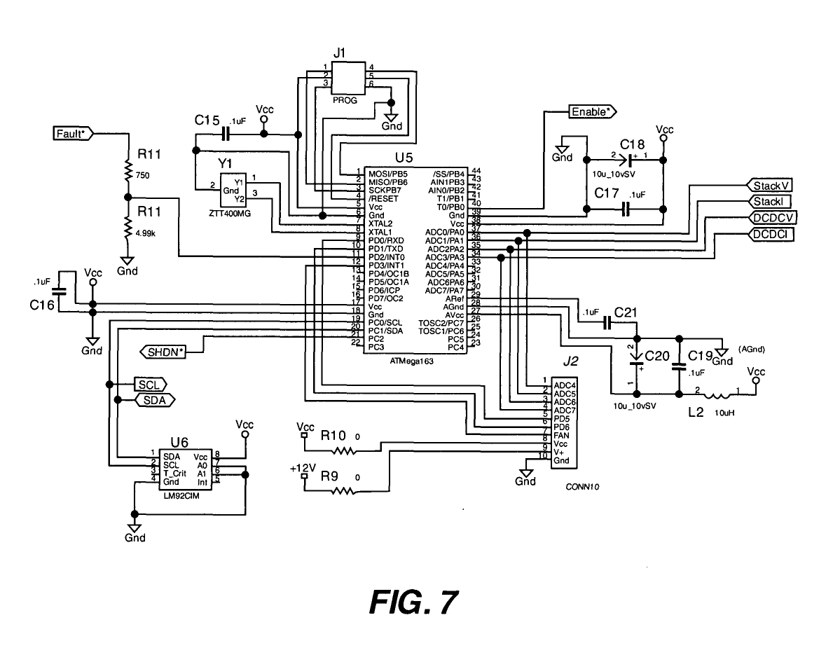

FIG. 4 schematically depicts the logical subcircuits that make up the regulator circuit of the present invention; these subcircuits are further detailed in FIGS. 5-8. The block labeled Interface (detailed in FIGS. 5a and 5b) shows the interconnections with the analog amplifiers/signal conditioning circuitry, labeled Analog, (detailed in FIG. 6), and the microcontroller, labeled Controller (detailed in FIG. 7), and the circuitry that drives the DC-DC converter output setpoint voltage, labeled Output Control, (detailed in FIG. 8). The signals that connect the logical blocks allow each logical block to perform its individual functions and communicate, control, or respond to the other logical blocks. The function of each of the logical blocks is detailed in the following paragraphs.

FIG. 5a schematically depicts the interface connections VI+1, VI−1, to the fuel cell stack, stack voltage dividers R3, R4, current shunt resistor R5 for monitoring stack current, DC-DC converter enable and fault circuitry U1, U3, R1, and R2, Vicor DC-DC converter DCI, output voltage dividers R7, R8, output current monitoring shunt R6, and DC-DC converter output control voltage VO+1, VO−1. Voltage dividers R3, R4, R7, R8, step down the input and output voltages to levels compatible with the analog-to-digital converter (ADC) in the Atmel ATMega163L micro-controller (detailed in FIG. 6). Current monitoring shunt resistors R5, R6 produce voltages proportional to current flow that are also measured by the ADC.

FIG. 5b schematically depicts the +12 and +5 volt regulated power supplies that exhibit a wide input voltage range (8 to 40 volts) which is required for this circuit to function properly. This part of the circuit is the power supply for the regulator circuit and allows the circuit to wake up and operate from well below normal voltage range for the stack to full voltage for the stack. It provides power for the rest of the circuit to operate at any time the stack is producing enough voltage that power control decisions should be made. It is also able to tolerate a wide swing on input voltage.

FIG. 6 is a schematic of the analog signal conditioning section monitoring the fuel cell stack and DC-DC converter output voltages and currents. Four Analog Devices AD629 high common mode voltage difference amplifiers, U7 through U10, are used to remove offset voltages and take the difference between signals from the individual current shunts, shown in FIG. 4, R4 and R5, and voltage signal inputs DCDCVH, DCDCVL, StackVH, StackVL. Voltages from current shunts R4, R5 are subsequently amplified by LM7301 operational amplifiers U11, U12. A 2.5 volt zener diode D2 is used to offset the output voltage of AD629 difference amplifiers U7, U8, U9, U10, from negative power supply rail Gnd, to prevent nonlinearity errors.

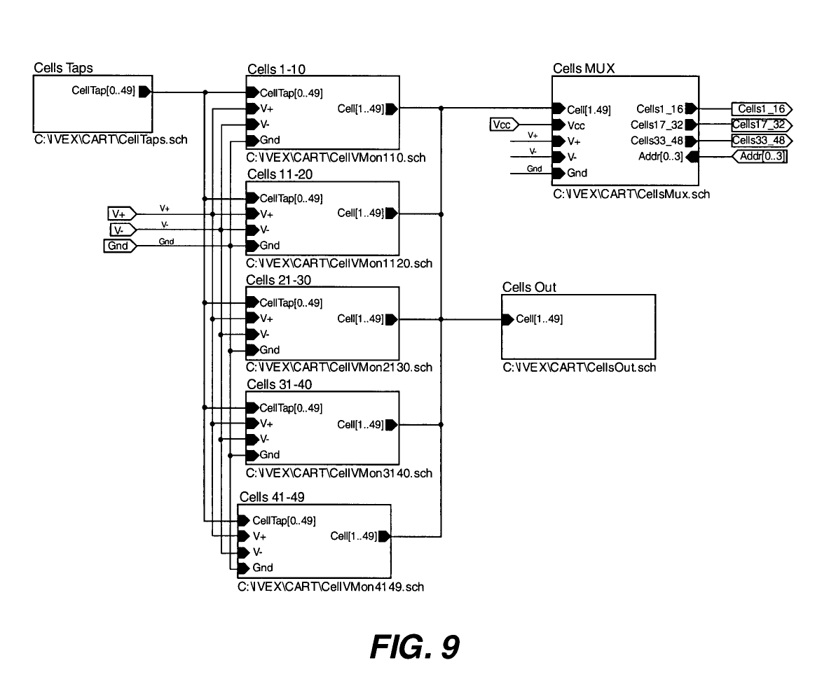

Atmel ATMega163L micro-controller U5 connections are shown in FIG. 7. The micro-controller executes programming stored in internal flash memory, communicates with an auxiliary circuit board (detailed in FIGS. 9-12) that scans individual stack cell voltages, controls the DC-DC converter output to regulate the fuel cell stack voltage, controls the fuel cell stack cathode fan based on power demand, and can monitor the circuit board temperature using LM92CIM temperature measurement integrated circuit U6. An “enable” signal from the micro-controller is used to turn the DC-DC converter on after circuit initialization and off if necessary to cut power drain on the stack to minimum levels.

FIG. 8 is a schematic of the DC-DC converter output voltage control circuitry. This circuit requires a power supply derived from the output voltage of the DC-DC converter because the voltage control signal must be referenced to the DC-DC converter output negative terminal. LM2936 5 volt regulator U17 is used to supply the control circuit power because it has adequate stability over a wide input voltage and temperature range, and is tolerant of high input voltages. Digital potentiometer U13 is used as a digitally controlled voltage divider, where the output voltage is buffered by LM3701 operational amplifier U18 before being applied to the secondary control pin of the DC-DC converter. The data inputs to the digital potentiometer are optically isolated by NEC PS9701 photocouplers U14, U15, U16 to allow control across a voltage offset between the logic and analog sections and the DC-DC converter output control circuit.

Advantages provided by the present invention include a lighter system weight and lower cost. Larger and more powerful fuel cell stacks are heavier and cost more than smaller and less powerful fuel cell stacks. In applications where stack costs constitute the larger fraction of lifetime system cost, by loading the stack to maximum power as much as possible, a smaller, lighter, and less expensive fuel cell stack may be used than if a larger and more lightly loaded stack were used. However, these advantages are at the expense of a lower fuel economy. The system handles continuous and high duty cycle pulsed loads, as long as the peak power requirements, and duty cycle are such that the battery is not completely discharged.

Normally, on startup, a hybrid battery pack configuration is frequently in a slightly discharged state due to self-discharge and accessory loads, and requires charging to bring the system to full power capacity. This initial system load is in addition to any external load. The controller ensures safe loading of the stack, as it recharges the battery and supplies external loads, and brings the hybrid fuel cell system to full power output capability faster than allowing the battery to supply actual and accessory loads until a fuel cell stack is fully operational and capable of delivering full output power before bringing the stack online.

The present invention alleviates a number of situations that reduce the ability of the stack to deliver power. If the stack is fully loaded during any of these conditions, individual cell potentials within the stack can be reverse biased and the cells damaged. First, high operating temperatures can lead to cell dehydration and reduced cell voltages in all cells or in sections of a fuel cell stack. Second, low temperatures and/or heavy loading leads to cell flooding and reduced cell voltage output due to physical obstruction of fuel and air flows to fuel cell membranes by water droplets. Last, low hydrogen fuel pressure, or a fan failure preventing the flow of oxygen to the stack, will reduce cell voltages by limiting power output capability.

To address these situations, regulation of the stack power output is based on individual cell voltages and overall stack output voltage. The regulation scheme protects the stack from damage during transient or prolonged loading under the conditions described. Monitoring individual fuel cell voltages in the stack also allows unloading the stack when one or more individual cells experience operational difficulty. Thus, the monitoring and regulation circuits allow the system to continue in operation, albeit at reduced power, until the problem or problems are rectified.

The operating point voltage value is chosen from a polarization curve for the fuel cell, see FIG. 3, to ensure maximum output power (−0.6 volts in this example). As power demands on the system decrease below the maximum power deliverable by the fuel cell stack, efficiency will automatically increase and power output will decrease regardless of the operating point voltage chosen. The operating point voltage is therefore the minimum voltage at which the fuel cell stack will be operated and where the stack will be operated when at maximum loading.

At maximum power draw on the fuel cell stack, the circuit holds the stack output at a fixed voltage. The control circuit regulates the power output of the fuel cell stack by varying the output voltage of the DC-DC converter. Only when the load is less than the maximum stack output power will the stack voltage be allowed to rise because the regulator circuit is no longer able to hold the stack in regulation.

A number of stack conditions may cause the maximum power that the fuel cell stack can deliver to vary. When the fuel cell stack is first started, the fuel cell membranes may have low water content (dry cell membrane) and therefore a low ionic conductivity. In addition, the air electrode kinetic activity decreases with increasing water content due to physical obstruction. These factors will cause the maximum power that the fuel cell stack can deliver to be reduced because the internal resistance and electrode overpotential for any given current are increased (see FIG. 3). The overall effect is that although the voltage range of the fuel cell stack remains the same, the current and, thus, power that the stack can deliver at a given voltage is reduced.

In order to hold the stack at a constant voltage, the regulator circuit must reduce the power output of the fuel cell stack, and, therefore, the output of the DC-DC converter. It does this by reducing the output voltage of the DC-DC converter into the system load electrical bus. As the system load is comprised of the battery and the actual load to which the fuel cell stack and battery are connected, by reducing the output voltage of the DC-DC converter, more load is placed on the battery. As long as sufficient energy remains in the battery, the fuel cell stack will deliver whatever power it can and the battery will deliver the balance. If the system has to supply a large load for a long enough period to exhaust the battery (an overload), the fuel cell stack can be electrically disconnected from the load by turning off the DC-DC converter.

Additional circumstances that can reduce or enhance the ability of a fuel cell stack to deliver power are stack temperature, fuel pressure, air (oxygen) pressure, and water accumulation in the gas diffusion and flow-field structures (flooding). All of these conditions can work to alter reaction kinetics or cell resistance, and, ultimately, the ability of a fuel cell stack to deliver current at a particular voltage. Regardless of the ability of the stack to deliver current at a particular voltage, the regulation circuit will not draw more power from the stack than it can deliver as the regulation is based on stack and individual cell voltages.

In either case, the output voltage of the DC-DC converter may only be adjusted over a fixed range or the range limits may be set in software. The circuit is configured such that the maximum voltage to which the DC-DC converter may be adjusted to is just below (˜90%) the full-charge voltage of the energy storage medium and the minimum voltage is well below any anticipated or operable system bus voltage. In this manner, it is always possible to limit the load on the fuel cell stack to near zero entirely through driving the output voltage of the DC-DC converter to the minimum voltage. As the regulator circuit attempts to maintain load on the fuel cell stack as the system load decreases, or the ability of the fuel cell stack to deliver power increases, the regulator will adjust the DC-DC converter output voltage to higher and higher values until the output voltage reaches the upper voltage adjustment limit—near the highest allowable voltage for the energy storage medium. Once the DC-DC converter output voltage is at the upper limit, any further decrease in system load cannot be accommodated, the regulator circuit is no longer able to regulate the fuel cell stack loading, and the fuel cell stack voltage begins to rise. This, however, represents operation at increased efficiency.

The system operates the fuel cell stack at highest power output that the fuel cell stack can supply until the battery is near the highest state of charge. This system then supplies the maximum power to the load that it can and allows sizing of the fuel cell stack and battery to minimize cost and weight. When power is not needed, the system automatically moves to a higher efficiency operating regime to conserve fuel while keeping the system at maximum stored power.

Another feature of the present invention includes the use of stack-monitoring circuitry as disclosed in FIGS. 9-12.

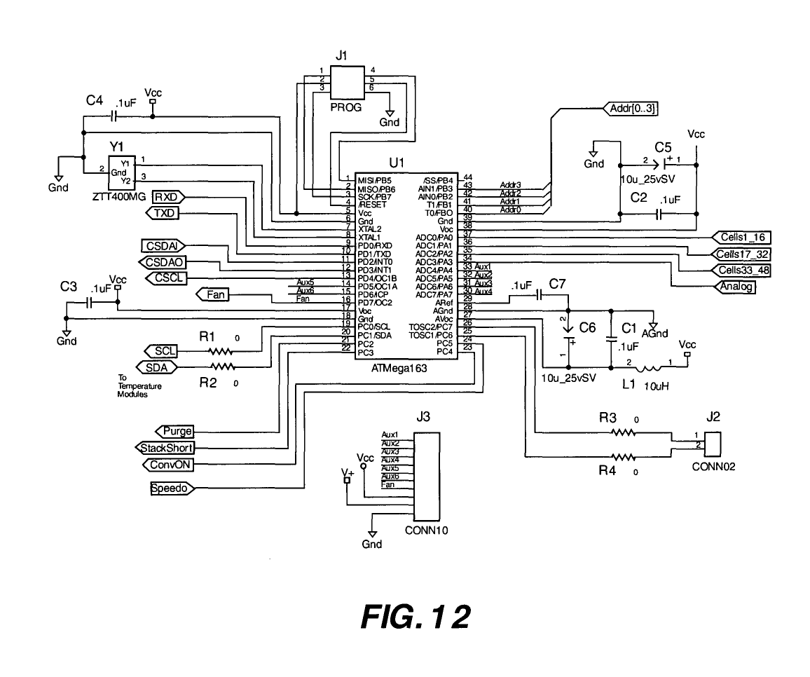

FIG. 9 is a schematic of the interconnections between functional blocks of the circuitry used to monitor individual cell voltages in the fuel cell stack. In this diagram, cell taps are the voltage measurement connections to each cell in the fuel cell stack. Cells 1-10 through Cells 41-49 are differential amplifiers that are used to remove common mode offset voltages and produce a unity gain, ground-referenced voltage for each cell in the fuel cell stack. Cell Mux is the multiplexing and filtering circuitry used to select which fuel cell voltages are applied to the microcontroller ADC (shown in FIG. 12) after filtering to remove high-frequency noise from the signal.

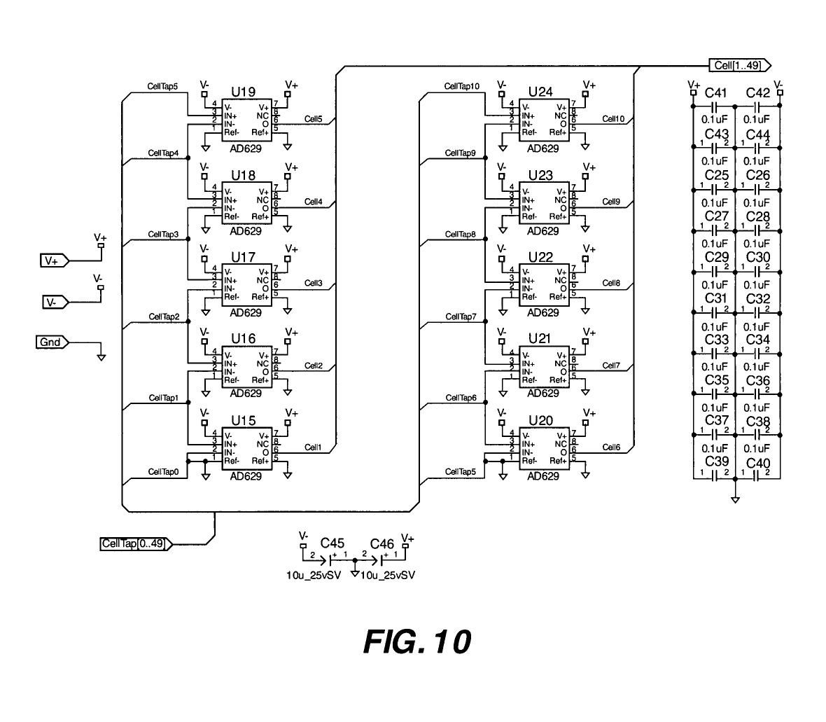

FIG. 10 is a schematic illustrating the connections between the fuel cell stack voltage taps and the Analog Devices AD629 difference amplifiers U15-U24. These amplifiers are used to eliminate the offset voltages present on all fuel cells. The cathode connection of one cell is common to the anode connection of another cell and is made at stack bipolar plates. This common connection forms the positive voltage measurement terminal of cell n and the negative terminal of cell n+1 as illustrated in FIG. 9. The AD629 difference amplifiers remove the voltage offset provided by all fuel cells connected below (cell n−1, n−2 . . . cell 1) the cell of interest and the resultant voltage is passed to multiplexing and filtering circuitry.

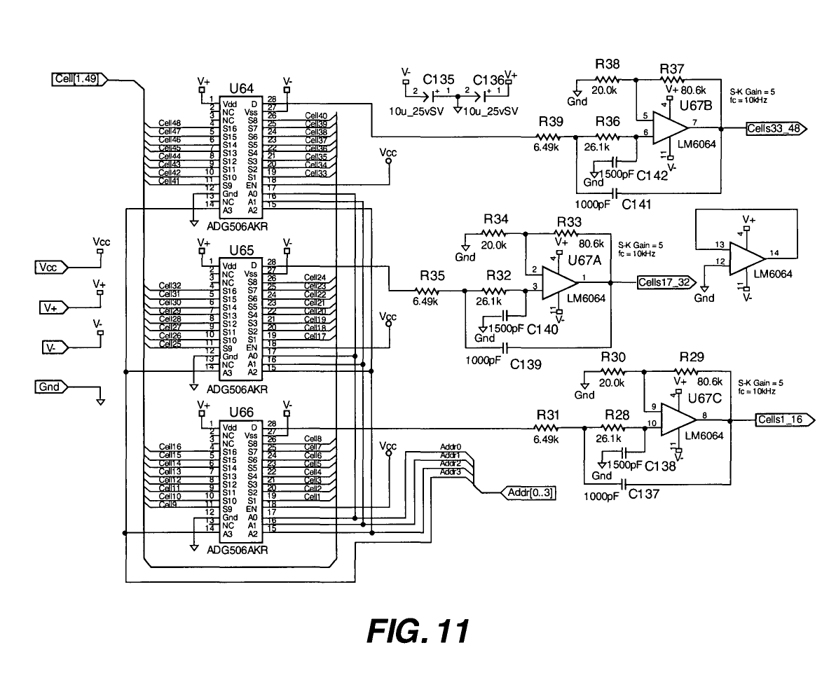

FIG. 11 is a schematic of the multiplexing and filtering circuitry that selects and performs low-pass filtering of the individual fuel cell voltages before they are passed to an ADC for digitization. Multiplexers U64, U65, U66 each select and connect the cell voltages from FIG. 9 to the filtering circuits. The cell to monitor for each multiplexer is chosen by writing a digital address on four address lines Addr0-Addr3. This signal is then passed to three identical Sallen-Key filters, U67A, U67B, U67C, that apply a gain value of 5 to the signal while cutting off noise components with frequencies above 10 kHz. The gain scales the 0-1 volt signals to 0-5 volts to better match the ADC input range.

FIG. 12 is a schematic of the connections to second ATMega163 microcontroller U1, that is used to scan, digitize, and check the voltages from individual fuel cells. It selects which cell voltage to measure by setting the address on Addr0-Addr3 and selecting which of analog inputs ADC0-ADC2 to digitize. The microcontroller checks each voltage level to decide if any are nearing warning or fault levels and then communicates this status to the regulator circuit microcontroller over data lines Aux5,Aux6.

This monitoring circuitry measures the voltage on each fuel cell in the stack and notifies the stack regulating circuit using a logic level signal if any cell potential is below the potential of the operating point voltage or in danger of reversal to a negative potential. The stack regulating circuitry then raises the fuel cell stack output voltage threshold value incrementally in order to decrease loading on the stack. By raising the stack output voltage level, the fuel cell stack operating point moves to lower current output on the fuel cell polarization curve (see FIG. 3) which decreases power demand on the fuel cell stack.

Not all fuel cells in a fuel cell stack can deliver the same amount of power. Weaker cells exhibit a lower cell voltage than stronger cells when the stack is under load. In extreme cases, the difference between cell voltages can be enough to drive weak cells to negative potentials and causing them to be damaged through reverse electrochemical processes, even though the output voltage of the stack is held at an otherwise safe value to maximize power output. When cells are driven to negative potentials, the cells are no longer producing power, but instead consuming power and reducing overall fuel cell stack power output. Conditions that induce these differences include: cell to cell variations in construction that impact the ability of the cells to produce power, flooding in cooler sections of the stack that reduce effective fuel cell active area, uneven fuel and oxidant gas distribution, and differences in temperature between fuel cells in the fuel cell stack.

Unbalanced cell voltage issues can also appear during stack startup. During this time, cell membranes may be drier near gas inlet ports, portions of the fuel cell stack may be below optimal operating temperature, or there may be air in the fuel manifold of the fuel cell limiting cell and stack performance through high resistance losses or other mechanisms. Usually the differences are transient in nature and the fuel cell stack will recover given enough time.

Monitoring individual cells is necessary while loading the fuel cell stack to maximum power output capability as overall fuel cell stack voltage will not reveal any single cell reversals. This becomes harder to detect as the number of fuel cells in the fuel cell stack increase and the loss of a single cell has a smaller effect on fuel cell stack total voltage. Through monitoring individual cells of the fuel cell stack, the stack may be loaded to maximum power output without driving any cells into reversal and causing damage.

The fastest way to hydrate membranes and warm up a single cell to proper operating temperature is to short the output as this promotes rapid cell membrane hydration through the maximum production of water in the fuel cell through the normal electrochemical process of combining fuel and oxygen in the fuel cell. In a fuel cell stack, this is not possible as individual cells will frequently exhibit wide variations in power output in a fuel cell stack that is being brought up to operating conditions. Many cells will be reversed and suffer various amounts of damage until the short is removed.

Loading the stack to maximum output without reversing any cells is the preferred method to bring the stack to rated maximum power output capability in the shortest amount of time. The present invention does this by monitoring the voltage across every cell in the fuel cell stack and not allowing the fuel cell stack to produce enough power that any one cell becomes electrochemically reversed. The fuel cell stack is driven to produce as much power as it safely can but no more. This has the additional benefit of increased efficiency by providing steadily increasing levels of usable power output during stack startup instead of wasting power through a short circuit. Note that if the battery is sized large enough to deliver operating power until the stack is fully online, the system will have no startup delay visible to the user.

It is difficult to anticipate power loading and duty cycle demands; priority is given to providing maximum power at all times. To do this requires the output of the DC-DC converter be kept at, or quickly reach, the voltage for optimal charge level of the battery. By always loading the fuel cell stack to the maximum power output voltage level for the stack, but being limited to a maximum output voltage near the battery voltage, the circuit regulates the output of the DC-DC converter to near the battery full-charge voltage while allowing for additional charging through regenerative braking, where forward momentum of the vehicle is braked by using the drive motor as a generator. When the drive motor is operated as a generator, the drive motor causes the vehicle to slow due to the drag of the generator as it converts momentum into electrical energy to charge the battery. If no regenerative source of energy is available, the maximum output voltage of the DC-DC converter should be adjusted to equal the maximum voltage of the battery in order to maximize stored energy.

In one embodiment, the stack cell voltage sensing circuitry is on a separate circuit board than the stack DC-DC converter regulating circuitry. However, in another embodiment, the stack cell voltage circuit and the regulating circuit are located on the same circuit board and the same micro-controller performs both functions. The DC-DC converter regulating circuit draws power from the fuel cell stack and becomes active at approximately 8.0 volts. This allows the circuit to monitor stack condition and control the DC-DC converter well below the 17-40 volt regulation range for the 40 fuel cell stack in the present embodiment.

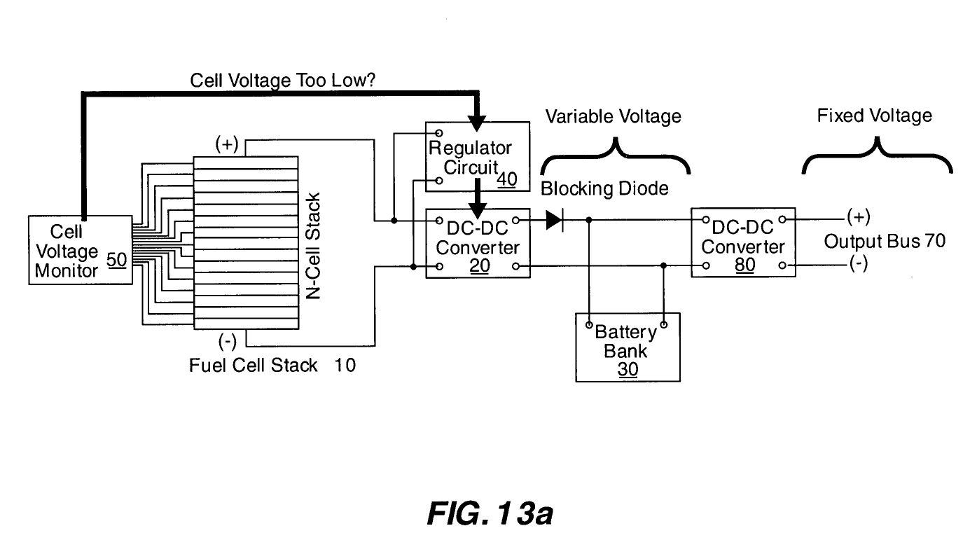

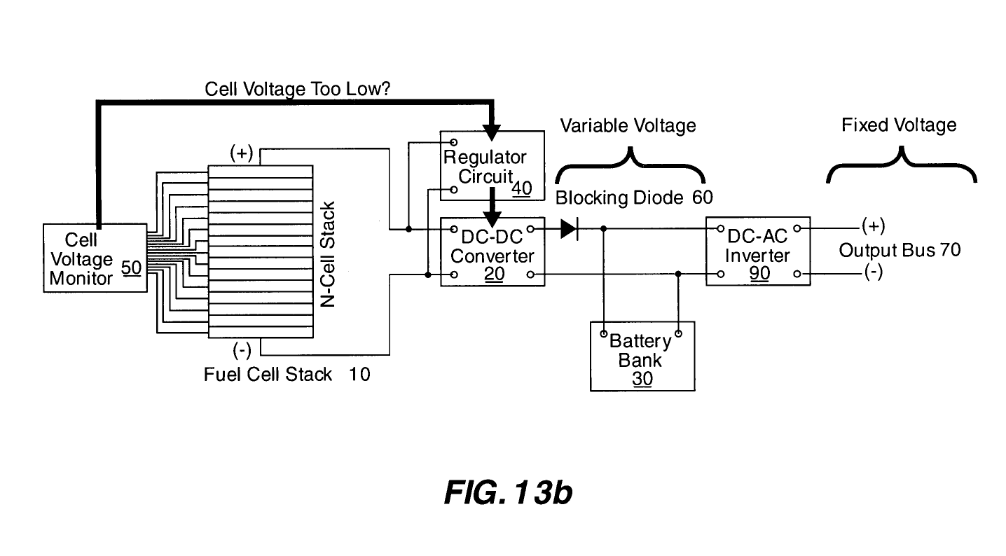

FIG. 13a pictorially illustrates how second DC-DC converter 80 can be placed on the output bus, down line of battery 30, to ensure a properly regulated output bus voltage for any given load. FIG. 13b pictorially illustrates how DC-AC inverter 90 can be placed on the output bus, down line of battery 30, to ensure a properly regulated output bus voltage for any given load.

### EXAMPLE

The following operational example of the present invention refers back to the regulation algorithm explained in FIG. 2 by reference to the particular step numbers in parentheses.

Hybrid Fuel Cell System and Regulation Circuit Design

The regulation circuit was installed in a hybrid fuel cell power system used to power a three wheel personal mobility vehicle. The hybrid fuel cell power system replaced a 24 volt, 32 ampere-hour lead acid battery originally installed to drive the vehicle motor speed controller and other powered accessories. The hybrid fuel cell power system was designed with a fuel cell stack consisting of 40 individual cells, providing 150-160 watt maximum power output. The energy storage medium used was a 24 volt, 7.2 ampere-hour battery, mounted under the floorboard of the personal mobility vehicle.

The stack regulation and cell warning point was set to 0.6 volts per cell. The cell alarm value was set to 0.10 volts. The DC-DC converter used was limited to an output maximum voltage of 26.4 volts. Maximum DC-DC converter power handling capability was 400 watts. During acceleration, the vehicle requires 600 watts of power. While cruising on a smooth, straight, and level surface, the power demand drops to 150 watts.

Although the fuel cell stack is technically undersized, placing even more stringent demands on the regulation circuit, the system successfully initialized, regulated, and protected the fuel cell stack. The output voltage of the DC-DC converter was adjustable in 56.2 mV steps from 12.0 volts to 26.4 volts. The step size of the regulated stack setpoint value was designed at 18.7 mV. The resolution of the stack voltage measurement was 39.2 mV. The regulated stack setpoint “safe” voltage was set to 30.0 volts.

System Startup

As hydrogen was first supplied to the fuel cell stack the stack began to generate power; voltage on the stack quickly rose to open circuit value (˜35 volts). Once the fuel cell stack was energized protection was afforded by a circuit breaker and the regulator circuit. Referring to FIGS. 2a and 2b, The microcontroller initialized (step 100) to the highest stack setpoint and lowest DC-DC converter output voltage, and began the main program loop (steps 110-350) to regulate the fuel cell stack power output.

If the cell voltage monitoring circuitry is not operational, the sampled warning and alarm signal levels (step 115) will be in a state of alarm but no warning. In this case, the regulating circuit uses a high enough voltage setpoint (step 140) to ensure that the stack operates with reasonable confidence that no single cell will be stressed enough to cause a reverse bias and damage. This allowed the fuel cell stack and regulator circuit to operate in situations where the battery becomes fully discharged and cannot operate other peripheral equipment. Under normal operation, the alarm and warning signals indicate that the cell voltage monitoring circuit is active, and that the stack may be loaded with confidence that reverse biasing of an individual fuel cell will be prevented (step 150).

As the stack is first starting up, there are no warning or alarm signals, as the stack is only experiencing the small load presented by the regulating circuit. The DC-DC converter was then turned on. As there are no warning or alarm signals, the program decreased the stack setpoint slightly (step 220) and then compared the initial stack voltage with the new setpoint (step 300). The stack voltage was above the setpoint, which indicated that stack loading should be increased to remain in regulation. The DC-DC converter output voltage was then increased (step 310) to increase the load on the stack, and the cycle started over again.

The fuel cell stack was progressively loaded, as the stack voltage setpoint was incrementally decreased by the regulation circuit, until one or more individual cells reach the warning voltage corresponding to maximum power (Step 160). In a normally functioning stack, all the fuel cells will be near the warning voltage value and producing near equal power output.

When the stack was finally driven to the warning setpoint (maximum power), the microcontroller controlled the stack between the maximum stack setpoint (step 190) and the minimum stack setpoint (step 210). The stack setpoint alternated between the minimum stack setpoint value and one increment above. As a result, the output of the DC-DC converter alternated up and down around an output voltage that maintained the actual stack output voltage equal to the time-weighted average of the stack setpoint voltages.

Note that when the fuel cell stack is first operated after an extended shutdown period it will most likely not be at operating temperature and the cell membranes will not be well hydrated (as in the case of a polymer electrolyte membrane); this can cause the initial power developed by the fuel cell stack to be low. However, operation of the stack at maximum power output serves to warm the stack to operating temperature and hydrate dry electrolyte membranes.

As the power generation capability of the fuel cell stack increased under a constant load, the voltage on the individual fuel cells increased. When the stack voltage became greater than the setpoint value (step 300), the output voltage of the DC-DC converter was increased by the microcontroller to drive more power into the load and the battery.

Vehicle Operation

Prior to engaging the vehicle to move, the regulating circuit was presented with a cumulative power load comprising vehicle accessories, motor speed controller, and the recharging power required by the less than fully charged battery. The regulating circuit rapidly moved the stack output voltage setpoint to a value corresponding to maximum power delivered by each cell (Point A in FIG. 3) by raising the output voltage of the DC-DC converter until the power could be absorbed by the battery and accessory loads (following steps 180, 210, 220, and 300-310-320). The battery charged at the maximum power output rate of the fuel cell stack minus the power delivered to the accessories and speed controller.

It should be noted that on startup, the maximum power delivery capability of the stack is rapidly changing while the stack warms to operating temperature and the cell membranes hydrate. The regulating circuit automatically compensated for this because the regulation of the stack is based on cell voltage.

If the vehicle were to remain idle indefinitely, the battery would be charged to the maximum output of the DC-DC converter, and the fuel cell stack would become unregulated because power load on the stack could no longer be maintained (steps 310-315). If this occurs, cell voltages increase towards Point B on FIG. 12 due to decreased loading on the fuel cell.

Vehicle Acceleration

As the vehicle was put into motion and accelerated, the power demanded by the vehicle speed controller increased to a value approaching 600 watts. The DC-DC converter output voltage setting initially caused the fuel cell stack to assume more load than it was capable of sustaining, which caused individual fuel cell voltages to decrease. The cell voltage monitoring circuit transmitted signals as one or more cell voltages began to reach the selected warning level (step 180). The regulating circuit then began to decrease load on the stack by lowering the output voltage level of the DC-DC converter (steps 300-330-340). The lowering voltage on the DC-DC converter output caused the battery to assume more of the load, and in so doing decreasing the load on the fuel cell stack.

The circuit eventually stabilized with the stack delivering its maximum output of 150 watts and the battery providing the 450 watt difference for a total of 600 watts, that required by the load. As the bus voltage varied during the acceleration period, the regulator circuit adjusts the output voltage of the DC-DC converter as necessary to maintain the stack setpoint value. As the vehicle reached constant speed, the system load began to decrease, and the regulator circuit increased the output voltage of the DC-DC converter to follow the bus voltage and maintain a load of 150 watts on the fuel cell stack (steps 300-340).

Constant Speed Vehicle Operation

Once the vehicle reached constant speed, the system load decreased to approximately 150 watts. This value is equal to the maximum output of the fuel cell power system, therefore all system power was supplied by the fuel cell stack. The battery had slightly discharged during acceleration and would exhibit a voltage output value slightly below the voltage reached during the idle charging period. The regulator circuit adjusted the output voltage of the DC-DC converter to match that of the battery so that no extra load is created on the fuel cell stack, as it is already at maximum load.

Vehicle Deceleration

During deceleration, if the deceleration rate is high enough, the vehicle drive motor is used for regenerative braking. At a minimum, the load on the system is greatly reduced due to the decreased demand by the drive motor. In the case of regenerative braking, the drive motor is used as a generator and the subsequent drag used to slow the vehicle. When used as a generator, the drive motor raises the bus voltage as it uses the power generated through braking to charge the battery. The fuel cell regulating circuit held the output voltage of the DC-DC converter constant until the decrease in load caused the cell and stack voltages to rise. To maintain load on the stack, the regulating circuit increased the output voltage of the DC-DC converter (steps 300-310-320). It did this until the load on the stack was re-established or until it reached the maximum output voltage setpoint for the DC-DC converter, in which case the stack became unregulated and moved to higher efficiency operation.

During deceleration, the drive motor and fuel cell stack both charge the battery. When the drive motor increases the bus voltage beyond the maximum DC-DC converter output value, the fuel cell regulating circuit automatically delivers less power, which maximizes the efficiency of the regenerative braking circuit and the fuel cell combination.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for controlling a fuel cell power system having a fuel cell stack with a connected energy storage medium, comprising:
(a) a voltage monitoring circuit connected to monitor individual voltages from one or more individual fuel cells forming said fuel cell stack;
(b) a regulating circuit connected to said voltage monitoring circuit, with said individual voltages as input, and outputting a control signal to regulate said fuel cell stack output voltage about a predetermined setpoint;
(c) a first DC-DC converter connected to said regulating circuit and said fuel cell stack, to receive said control signal and outputting a new voltage corresponding to a maximum power that said fuel cell stack can provide and supplying said new voltage to an output bus and said energy storage medium.

2. The apparatus of claim 1, further including a blocking diode connected between said first DC-DC converter and said output bus to prevent reverse electrical current flow from said output bus into said first DC-DC converter.

3. The apparatus of claim 1, where said energy storage medium is a battery.

4. The apparatus of claim 1, further including a second DC-DC converter connected between said energy storage medium and said output bus for receiving a variable voltage from said fuel cell power system and providing a fixed DC output voltage to said output bus.

5. The apparatus of claim 1, further including a DC-AC inverter connected between said energy storage medium and said output bus for receiving a variable voltage from said fuel cell power system and providing a constant AC output voltage to said output bus.

6. A method for controlling a fuel cell stack with a connected energy storage medium, comprising:
(a) monitoring one or more individual fuel cell voltages within said fuel cell stack with an individual cell voltage monitor;
(b) setting a stack voltage setpoint within a regulator circuit for operating said fuel cell stack at a maximum power output;
(c) modifying said voltage setpoint to a higher voltage value through said regulator circuit when said individual cell voltage monitor generates a signal that one or more individual fuel cells are in danger of experiencing reverse voltage bias; and
(d) controlling a DC-DC converter connected between said fuel cell stack an said energy storage medium with said regulator circuit to maintain a regulated voltage output to an output bus corresponding to said maximum power output.

7. The method of claim 6 further comprising the steps of:
monitoring operation of said individual cell voltage monitor; and
resetting said voltage setpoint when it is determined that said individual cell voltage monitor is not functioning properly.

8. The method of claim 6 further comprising the steps of:
monitoring operation of said individual cell voltage monitor; and
turning off said DC-DC converter when it is determined that said fuel cell stack is experiencing low cell voltage that could damage said fuel cell stack.

9. The method of claim 6 further comprising the steps of:
monitoring an output voltage of said fuel cell stack; and
decreasing said stack voltage setpoint when it is determined that all individual fuel cell voltages are not at a warning setpoint and said one or more individual fuel cells are capable of delivering more power than is being delivered to said output bus.

10. The method of claim 6 further comprising the steps of:
monitoring operation of said individual cell voltage monitor; and
increasing said stack setpoint voltage when it is determined that said one or more individual fuel cells are not capable of supplying the power required of a load on said output bus.

11. The method of claim 6 further comprising the steps of:
monitoring said regulated voltage output of said DC-DC converter; and
decreasing said regulated voltage output of said DC-DC converter when it is determined that said fuel cell stack is loaded beyond said maximum power output.

12. The method of claim 6 further comprising the steps of:
monitoring said regulated voltage output of said DC-DC converter; and
increasing said regulated voltage output of said DC-DC converter when it is determined said fuel cell stack is not at maximum power output.
